(19) United States
(12) Patent Application Publication
(10) Pub. No.: US 2006/0246930 A1
(43) Pub. Date: Nov. 2, 2006

(54) Method for handling propagation delay in a wireless communication system

(76) Inventors: Chang H. Kim, Whippany, NJ (US); Lawrence J. Merboth, Bridgewater, NJ (US); Susan M. Miller, Whitehouse Station, NJ (US); Paul Anthony Polakos, Marlboro, NJ (US); Stephen A. Wilkus, Lincroft, NJ (US); Henry Hui Ye, Ledgewood, NJ (US); Lily H. Zhu, Parsippany, NJ (US)

Correspondence Address: HARNESS, DICKEY & PIERCE, P.L.C., P.O. BOX 8910, RESTON, VA, 20195, US

(21) Appl. No.: 11/318,482

(22) Filed: Dec. 28, 2005

Related U.S. Application Data
(63) Continuation-in-part of application No. 11/115,169, filed on Apr. 27, 2005.

(51) Int. Cl. H04B 7/00; H04B 15/00

(52) U.S. Cl. 455/504; 455/501; 455/506

(57) ABSTRACT

In one embodiment of the method, a base station is configured to divide a coverage area of the base station into sub-coverage areas. Each sub-coverage area has a smaller range of round trip propagation delays than a range of round trip propagation delays for the coverage area of the base station. Each sub-coverage area may have a different range of round trip propagation delays.

### DOMESTIC PRIORITY INFORMATION

This is a continuation-in-part application of application Ser. No. 11/115,169 filed Apr. 27, 2005; the entire contents of which are hereby incorporated by reference.

### BACKGROUND OF THE INVENTION

In regular cellular communication systems the mobile stations (MS) communicate with base stations (BS) that are within a few kilometers to a couple of hundred kilometers distant. In this case the propagation delay, which is defined as the delay encountered by the signal traveling from BS to MS or, equivalently, the delay encountered by the signal traveling from MS to BS, is within a corresponding range that is proportional to the distance between the MS and BS, typically a few microseconds to a few hundred microseconds.

However, in some certain applications, the signals traveling from BS to MS or from MS to BS can encounter extremely long propagation delay. For example, some service providers are interested in using geosynchronous satellites to communicate between mobile stations and base stations that may be half a continent away. This can happen when a MS is in an area where there is no BS deployed. In this case, the service providers can use satellite(s) to relay the signals between the MS and a BS that can be thousands of kilometers away. As a result, the absolute propagation delay of the signal traveling between MS and BS, through the satellite is, extremely long since the distance the signal travels is on the order of tens of millions of meters. In addition, the range of the differential delay, i.e., the difference between the upper bound of the propagation delay and the lower bound of the propagation delay, is also very large. This is because the distance between a MS on the earth and a satellite in space can vary significantly (on the order of thousands of kilometers) depending on the physical location of that MS.

The current CDMA BS products appear unable to support such extremely long propagation delays due the following:
general baseband modem processors (implemented as an application specific integrated circuit (ASIC), field programmable gate array (FPGA), or digital signal processor (DSP)) in the BS cannot demodulate signals with extremely long propagation delay, and
some call processing timing requirements may be violated.

Next, how the MS and the BS are synchronized in a conventional system will be described. The BS uses prescribed pseudo random PN codes (such as a long code and a short code) to scramble its transmitted signals. The MS can then detect the states of those PN codes at the MS receiver. In addition, the MS also uses some certain pseudo random PN codes, which could be different from what the BS uses, with states aligned to the detected BS PN code states to scramble its outputs. The BS receiver can use the received signals from the MS to detect the states of the MS's PN codes. The difference between the BS transmitter's PN code states and the detected MS's PN code states at the BS indicates the round trip propagation delay between the MS and BS.

The BS baseband modem processor is in general implemented in ASIC/FPGA/DSP devices. For example purposes, implementation as an ASIC device will be described. In order to demodulate the signals sent from the MS, the BS ASIC needs to align the PN code states to the received signals appropriately. This can be described mathematically by the following equations.

Assume the BS received signal is R(t), then
R(t)=S(t−d)*PN(t−2d)+N(t), (1)
where S(t) is any given mobile's signal, PN(t) is the scrambling code (e.g., PN code(s)) used by the MS, N(t) is the total noise including all other mobiles' valid signals (that are interference to this mobile) and all other noises, and d is the one way delay between the MS and BS.

Notice that the PN code states are delayed by “2d” because the mobile uses the received signals from the BS to determine its PN code states, and the signals received by the MS are delayed by “d”. In order to remove the PN codes, the BS needs to multiple R(t) by PN(t−2d) to get the original transmitted signal from MS, i.e.,

$$R ( t ) * PN ( t - 2 d ) = S ( t - d ) * PN ( t - 2 d ) * PN ( t - 2 d ) + N ( t ) * PN ( t - 2 d ) = S ( t - d ) + N ( t ) * PN ( t - 2 d ) \qquad ( 2 )$$

The above equation implies that the BS needs to use PN(t−2d) at the time t where 2d is the round trip delay (round trip delay is the sum of the delay from BS to MS and the delay from MS to BS). The value of the round trip delay 2d relates to the distance between the MS and the BS. The conventional BS in cellular communications can support communications between MS and BS that are up to 100 to 200 kilometers apart. In other words, it means that
0<=2d<=M (3)
where M is on the order of 0.66 ms (corresponding to 100 kilometers) to 1.33 ms (corresponding to 200 kilometers).

Equation (2) implies that the ASIC needs to generate PN(t−2d) at time t. This should be easily achievable if the ASIC only needs to demodulate the signal from a single MS. However, most state of art ASIC solutions in a BS handle signals from multiple mobile stations. In addition, the BS may have multiple arrays receiving from each MS and therefore requires multiple rake finger processing. This means the ASIC needs to generate I*J PN code states at time t if the ASIC is to demodulate signals received from I mobile stations and an average of J rake fingers are assigned to each MS. Therefore, an alternative method that is widely used in BS ASIC solutions is to store the raw received data R(t), where R(t) is the composite received signals from all the mobiles plus noises. This is because the BS ASIC can remove any mobile's PN code to obtain that mobile's original transmitted signal s(t) by performing the following operation at the time t:

$$R ( t - M + 2 d ) * PN ( t - M ) = S ( t - M + d ) * PN ( t - M + 2 d - 2 d ) * PN ( t - M ) + N ( t - M + 2 d ) * PN ( t - M ) = S ( t - M + d ) + N ( t - M + 2 d ) * PN ( t - M ) \qquad ( 4 )$$

Since 0<=2d<=M, equation (4) implies that BS ASIC needs to store all the received signals R(u) for t−M<=u<=t at time t. This usually requires only a few megabits or less memory space which can be readily implemented by the current generation of ASIC devices. Note that there is no need to store PN code sequences since PN(t-M) can be generated at time t.

### SUMMARY OF THE INVENTION

The present invention provides methodologies for handling propagation delay.

In one embodiment, a base station is configured to divide a coverage area of the base station into sub-coverage areas. Each sub-coverage area has a smaller range of round trip propagation delays than a range of round trip propagation delays for the coverage area of the base station. Each sub-coverage area may have a different range of round trip propagation delays. For example, the different ranges of round trip propagation delays may be non-overlapping. In one embodiment, the sub-coverage areas are concentric.

In one embodiment, the configuring step assigns a different processing device of the base station to each sub-coverage area. For example, each processing device may be one of an ASIC, FPGA and a DSP.

In one embodiment, each processing device includes a receiver and the configuring step skews the reference time of each receiver so that each processing device sees a different range of round trip propagation delays. For example, the configuring step may skew the reference time of at least one receiver by shifting a PN sequence of the receiver.

As another example, a timing signal used by the receiver is delayed to skew the reference time. For example, the timing signal may be the well-known one-pulse-per-two-seconds or PP2S signal generated by GPS systems. In this example, the reference time used at a transmitter of the processing device may also be affected by delaying the timing signal. According to at least one embodiment, the affect of this delay is at least reduced or eliminated.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates an example of a wireless communication system having long round trip propagation delays; and

FIG. 2 illustrates an example of dividing a coverage area into rings and assigning an ASIC at a base station to each ring.

FIG. 3 illustrates a board level hardware implementation for an embodiment of skewing a reference time at a receiver according to the present invention.

### DETAILED DESCRIPTION OF THE EMBODIMENTS

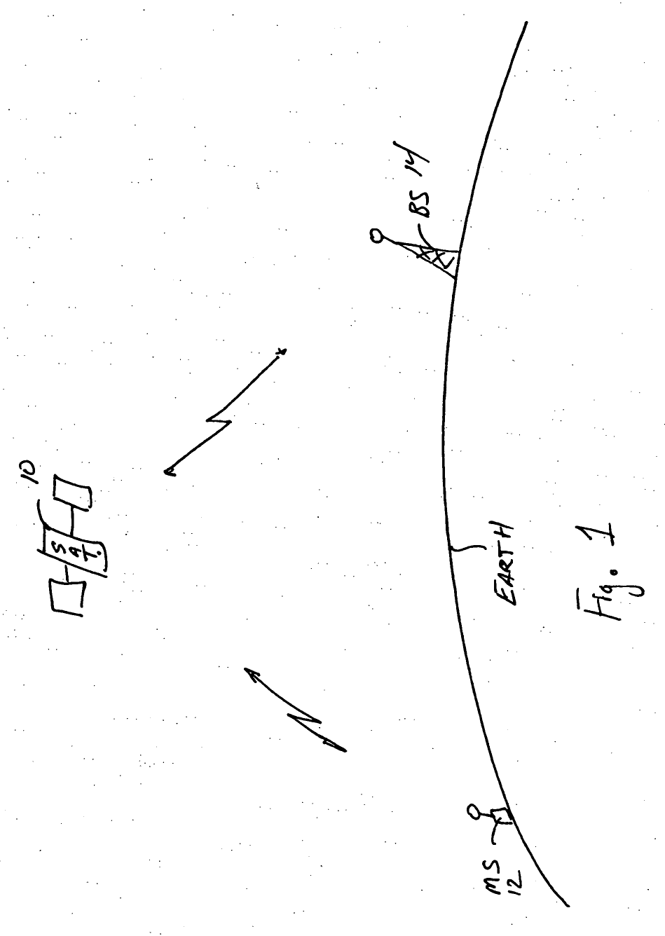

As mentioned earlier, in some certain applications, the round trip propagation delay can be extremely long, on the order of many hundreds of milliseconds. For example, as shown in FIG. 1 some service providers are interested in using geosynchronous satellites 10 to communicate between mobile stations (MSs), such as mobile station 12, and base stations (BSs), such as base station 14, that may be half a continent apart. This can happen when a MS is in an area where there is no BS deployed. In this case, the service providers can use satellite(s) to relay the signals between the MS and a BS that may be thousands of kilometers apart. As a result, the round trip propagation delay is extremely long. This delay consists of the propagation delay from the base station to the satellite, plus the delay from the satellite to the mobile station, plus the return trip from the mobile station to the satellite and again the delay from the satellite back to the base station. For example, for some satellites the total round trip propagation delay may be around 500 ms.

While 500 ms becomes the upper bound of the propagation delay in this example, it should be noted that the lower bound of the propagation delay is also quite large. Also, it will be appreciated that this upper bound is merely an example, and the present invention is not limited to this example.

We use T_low to represent the lower bound propagation delay for this kind of application and T_high to represent the upper bound propagation delay, such that:
T_low<=2d<=T_high (5)
where 2d is the actual round trip propagation delay. While both T_low and T_high are very large (e.g., in the order of 500 ms), the differential delay, T_high-T_low, can be also quite large (e.g., on the order of 10 ms).

A straightforward extension of the solution in the current art as described in equation (4) would be performed at the time t as follows:
R(t−T_high+2d)*PN(t−T_high) (6)

This would require the baseband modem processors, implemented as an ASIC in the example embodiments of the present invention, to store R(u) for all u such that t−T_high+T_low<=u<=t at the time t. However, this requires an unrealistic amount of storage in ASIC and would introduce unacceptable ASIC cost and power consumption. In the following, an efficient method to support this kind of application, where extremely long propagation delays are encountered, is discussed.

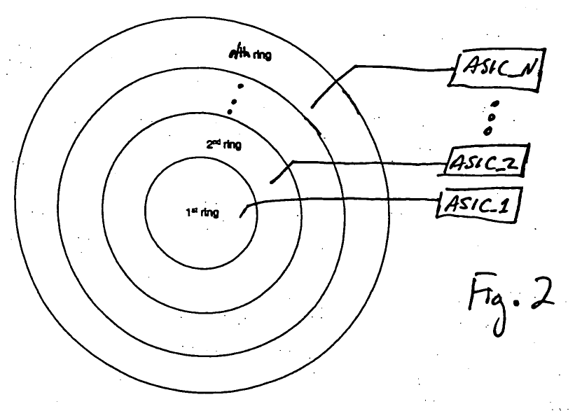

Recall that the current BS ASIC products generally support propagation delay in the range of 0 to M where M is on the order of 0.66 ms to 1.33 ms as shown in equation (3). First, without loss of generality, assume T_low=L*M for some integer L and T_high=(L+N)*M for some integer N. Alternatively, the value for T_high may be changed and/or the value for T_low may be changed so that both are multiples of M. With the understanding that (1) L*M and (L+N)*M are very large (e.g., on the order of 500 ms), (2) T_high-T_low=N*M is large (e.g., on the order of 10 ms), and (3) most ASICs store the received data for a duration of M, the coverage area for a long propagation delay system element (e.g., the coverage area of the satellite 10 in FIG. 1) is divided into N geographic rings. For example in one embodiment, the coverage area is divided into N concentric rings as shown in FIG. 2 such that the mobile stations within each ring have their round trip delays 2d satisfy the following condition:
First ring: LM<=2d<(L+1)M,
Second ring: (L+1)*M<=2d<(L+2)*M
The N-th ring: (L+N−1)*M<=2d<=(L+N)*M (7)

FIG. 2 illustrates geographic rings projected upon the earth with lines corresponding to points equidistant from the satellite to the curved surface of the earth.

As shown in FIG. 2, the center of all those rings (which all have the same center) is at the point that has the least round trip delay 2d=T_low=L*M. This can be the spot on the earth that is closest to, for example, the satellite 10 in the example mentioned previously with respect to FIG. 1.

Each ring is supported by a dedicated ASIC at the base station. In other words, the BS may be equipped with at least N ASICs: ASIC_{—}1, ASIC_{—}2, . . . , ASIC_N, and the ASIC_k is used to support the mobile stations in the k-th ring for k=1, 2, . . . , N in the manner described below. While this embodiment uses ASICs as the base station modem processing device, the present invention is applicable to the use of any processing device such as ASICs, FPGAs, DSPs, etc. or a combination thereof.

Note that the propagation delay 2d for any MS inside the k-th ring satisfies:
(L+k−1)*M<=2d<(L+k)*M (8)

However, the BS ASIC only supports 0<=2d<M in general. Therefore, this ASIC's receiver reference time is artificially skewed by (L+k−1)*M so that the round trip propagation delay seen by the ASIC is between 0 and M. This ensures that the mobile stations in the k-th ring are successfully processed by the ASIC. Note that the ASIC's transmitter reference time is not skewed.

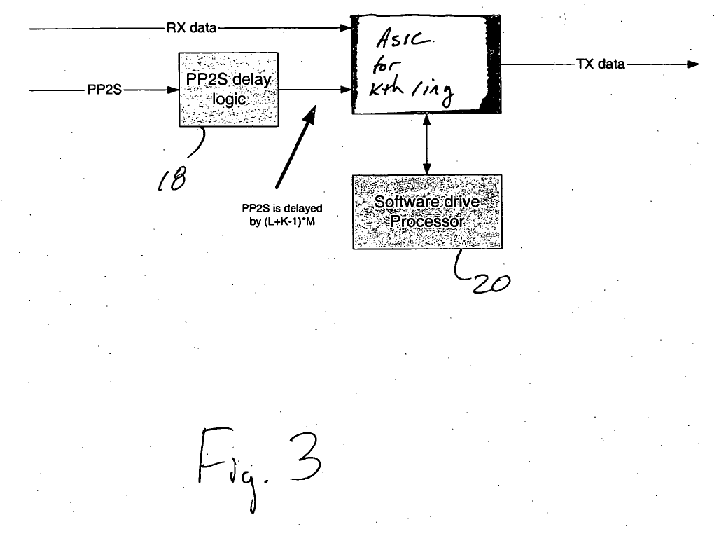

There are multiple ways to shift the ASIC receiver's reference time. To better understand two different examples on how to shift the receiver's reference time, the well-known process of how the ASIC generates PN codes based on GPS time will be briefly described. For the purposes of example only, this description will be based on the CDMA 2000 standard. The CDMA standard requires that base stations be synchronized to GPS time. One of the GPS timing derived signals is the one-pulse-per-two-seconds or PP2S timing signal. This signal produces a short pulse at every even second instance starting from the beginning of the GPS time (i.e., Jan. 6, 1980 00:00:00). This pulse is therefore also referred to as the 2-second-tick. The ASIC relies on PP2S to synchronize itself with GPS. When the ASIC is first powered up, the ASIC waits for the occurrence of the next 2-second-tick, which corresponds to an even second boundary. Then the ASIC loads initial states for the long PN codes (one for receiver and one for transmitter) and initial states for the short PN codes (one for receiver and one for transmitter), and starts incrementing both long PN codes and short PN codes. It should be pointed out that, even though the long PN code states for the receiver and transmitter are the same, the ASICs in general have separate long PN code generators in the receiver and the transmitter so that they can be designed independently and operate along independent fine timelines. Because the long PN codes wrap around roughly every 37.7 days and the ASIC does not, generally, determine what the states should be for any 2 ms boundary, a software driver, which is described in more detail below with respect to FIG. 3, calculates the initial states for the long PN codes that corresponds to the next 2-second-tick and sends them to the ASIC so that the ASIC can load the long PN codes when the 2-second-tick arrives. Note that in normal operations the long PN code initial states for the transmitter and the receiver are in general identical, but the interface between the software driver and the ASIC allows independent initial states to be used for transmitter and receiver.

The short PN codes wrap around every 26.666 ms. This implies the initial state for each short PN code corresponding to every 2-second-tick is the same because the short PN code wraps around exactly 75 times in 2 seconds. Unlike the long PN codes, in the CDMA standard, the short PN codes are different between the transmitter and the receiver. More specifically, the state of the receiver's short PN code at every 2-second-tick is the 16-bit fixed value “100 . . . 0”, while the state of transmitter's short PN code at every 2-second-tick has 512 possible values, each of which is offset from receiver's initial state by 0 chips, or 64 chips, or 64×2 chips, . . . , or 64×511 chips. The exact offset value used is based on the specific deployment scenario, with the goal that the offset used in any sector of a BS is different from the ones used by other sectors of the same BS or nearby BSs to minimize interferences. Therefore, the initial state of the transmitter's short PN code is often programmable and the ASIC relies on the software driver to indicate the PN offset it should use. On the other side, the initial state of the receiver's PN code may or may not be programmable. Depending on the specific implementations, some ASICs may still allow the software driver to program the initial state, while other ASICs may simply hardcode the initial state to “100 . . . 0” and do not allow any programmability. Two different methods to skew the receiver's reference time are described next based on whether the initial state of the receiver's short PN code is programmable.

One method is to directly shift the receiver's PN sequence if the initial state of the short PN code is programmable. For example, according to one embodiment each ASIC receiver's PN sequence is shifted by (L+k−1)*M, such as according to the following expression:
PN_new (t)=PN(t−(L+k−1)*M), (9)
where PN_new(t) is the new PN sequence that is a delayed version of the original PN sequence PN(t). Note that PN_new(t) may be automatically generated in the ASIC by changing the initial states of the PN codes by (L+k−1)*M for both the short PN code and the long PN code used in the receiver. Viewed another way, the initial state of the PN code for an ASIC, denoted by PN_new(0), may be configured according to the following equation:
PN_new (0)=PN(−(L+k−1)*M). (10)

The procedure discussed above provides a way to skew the receiver's reference time so that the ASIC can properly demodulate the signal coming from the MS. Also, the ASIC delays the frame boundaries accordingly so that the ASIC can capture received frames properly and decode them properly. As is known, the reverse link channels in CDMA have certain frame-offsets, where the frame-offset of a channel is defined as the distance between a 2-second-tick and the nearest frame boundary of that channel after the 2-second tick. When the software driver conventionally configures a reverse link channel, the software driver informs the ASIC of the frame-offset associated with that channel along with other information. Therefore, when the receiver reference time is delayed, the software driver adjusts the frame-offset accordingly for each reverse link channel in the receiver so that the frame boundary is delayed as was the receiver's reference time.

Next, a second embodiment for skewing or shifting the receiver reference time at the ASIC without requiring programmability of the initial state of the receiver short PN code will be described in detail. According to this second embodiment, the GPS timing signal PP2S that goes to the k-th ASIC may be delayed by (L+k−1)*M. Note that this may be easily done by any programmable device such as FPGAs in the board that hosts the ASIC as will be described below with respect to FIG. 3. Recall that the ASIC loads the initial states for both short PN code and long PN code in the receiver at every 2-second-tick. Therefore, delaying the 2-second-tick will cause the initial states to load at a later time, and the reference time at the receiver is effectively delayed as well.

More specifically, and as described below with respect to FIG. 3, in implementation, the PP2S signal may be delayed easily through a simple counter in a programmable device on the board. Also, the delay value for the PP2S may be programmable so that different values may be used to support different coverage rings. For example, the PP2S shall be delayed (L+k−1)*M for the k-th ring.

While delaying the PP2S signal delays the receiver reference time by (L+k−1)*M as desired, this also unnecessarily delays the transmitter reference time at the kth ASIC by (L+k−1)*M. This is because the transmitter also uses the 2-second-tick to derive its internal timing and downloads the initial states for its short and long PN codes. Since the initial states for both the short and long PN codes in the transmitter are programmable as described previously, the unwanted skew in transmitter reference time caused by the delayed 2-second-tick can be removed. The skew in both the short PN code and long PN code can be removed by the software driver adjusting the initial states of the transmitter's PN short code and long code by −(L+k−1)*M assuming M is a multiple of 64 chips. Namely, these operations eliminate, or at least reduce, the effect delaying the PP2S signal has on the short and long PN codes.

The procedure discussed above provides a way to remove the skew in the PN codes caused by the delayed 2-second-tick. There are some other effects caused by the delayed 2-second-tick that may also be mitigated. As is known, the forward link channels in CDMA have certain frame-offsets, where the frame-offset of a channel is defined as the distance between a 2-second-tick and the nearest frame boundary of that channel after the 2-second tick. When the software driver conventionally configures a forward link channel, the software driver informs the ASIC of the frame-offset associated with that channel along with other information. Therefore, when the 2-second-tick is delayed according to the second embodiment, the software driver adjusts the frame-offset accordingly for each forward link channel in the transmitter so that the frame boundary remains in time relation to the original 2-second-tick. Namely, the adjustment eliminates, or at least reduces, the effect delaying the PP2S signal has on the frame offset.

FIG. 3 illustrates a board level hardware implementation for this second embodiment. As shown, the modem processor for the k-th ring may be regular base band modem processor implemented as an ASIC. The ASIC receives received data RX_data from the radio for the reverse link and generates transmission data TX_data for the radio for the forward link. The ASIC also receives the PP2S signal for synchronization purposes. The PP2S signal is received via PP2S delay logic 18, and delayed, for example, by a counter or other conventional delay element(s) in the PP2S delay logic 18 before being sent to the ASIC. The delay value used at the PP2S delay logic 18 may be configurable so that the same structure of the PP2S delay logic 18 may be used to support any of the rings. Assuming this board is used to support the k-th coverage ring as shown in FIG. 2, the delay value programmed in the delay logic 18 would be (L+k−1)M. In addition, the software driver processor 20 that controls the ASIC may perform the following for the ASIC's transmitter:
Adjusting the long PN code initial state by −(L+k−1)*M chips.
Adjusting the short PN code offset value by −(L+k−1)*M chips.
Adjusting the frame offset of each channel by −(L+k−1)*M chips.

According to this second embodiment, the PP2S signal that goes to an ASIC is delayed so that the reference times in both the receiver and the transmitter are delayed, and the initial states of both the short PN code and the long PN code in the transmitter of the ASIC are changed to “undo” the effect of the delayed PP2S on the transmitter's reference time.

Returning to FIG. 2, note that when a MS moves from one ring to another ring, MS processing is migrated from one ASIC to another ASIC. Since each ring may cover a distance on the order of 100˜200 kilometers, the frequency of having to migrate a MS is quite low and therefore should not incur much overhead to the overall system.

There are certain timing requirements inside the base stations and mobile station for various call processing applications. If the base station or the mobile station has not received certain messages from the other by the time limits specified by the timers inside BS and MS, it assumes some of the previous communications have failed and may take some new actions. While most of the time limits specified by those timers are quite long (i.e., above 1 second), a few of them are in the range of 500 ms to 1 second. For those specific timers, the limits may be lengthened.

Note that power control is used in general CDMA communication systems. In CDMA power control fast interactions between BS and MS with delays in the range of 1-2 microseconds are preferred. When the total propagation delay is extremely long, the power control may be turned off.

The invention being thus described, it will be obvious that the same may be varied in many ways. For example, while an example implementation of the present invention has been described with respect to a CDMA system, it will be appreciated that the present invention is applicable to other standards based systems. Such variations are not to be regarded as a departure from the invention, and all such modifications are intended to be included within the scope of the invention.

We claim:

1. A method, comprising:
configuring a base station to divide a coverage area of the base station into sub-coverage areas, each sub-coverage area having a smaller range of round trip propagation delays than a range of round trip propagation delays for the coverage area of the base station.

2. The method of claim 1, wherein each sub-coverage area has a different range of round trip propagation delays.

3. The method of claim 2, wherein the different ranges of round trip propagation delays are non-overlapping.

4. The method of claim 1, wherein the configuring step assigns a different processing device of the base station to each sub-coverage area.

5. The method of claim 4, wherein each processing device is one of an ASIC, FPGA and a DSP.

6. The method of claim 4, wherein each processing device includes a receiver and the configuring step skews the reference time of each receiver so that each processing device sees a different range of round trip propagation delays.

7. The method of claim 6, wherein the configuring step skews the reference time of at least one receiver by shifting a PN sequence of the receiver.

8. The method of claim 6, wherein the configuring step shifts the PN sequence of the receiver by skewing the initial PN code of the receiver.

9. The method of claim 8, wherein the different ranges of round trip propagation delays are non-overlapping.

10. The method of claim 8, wherein the sub-coverage areas are concentric.

11. The method of claim 6, wherein the range of round trip propagation delays seen by each processing device is a multiple of the range of round trip propagation delays supported by the processing device.

12. The method of claim 11, wherein the different ranges of round trip propagation delays are non-overlapping.

13. The method of claim 11, wherein the sub-coverage areas are concentric.

14. The method of claim 11, wherein the sub-coverage areas are concentric.

15. The method of claim 6, wherein the configuring step skews the reference time of at least one receiver by delaying a timing signal used by the receiver.

16. The method of claim 15, wherein the timing signal is a GPS timing signal.

17. The method of claim 16, wherein the GPS timing signal is a 2-second-tick timing signal.

18. The method of claim 15, wherein the timing signal is used to synchronize timing at the base station.

19. The method of claim 15, wherein the processing device includes a transmitter, and the configuring step adjusts at least one PN sequence of the transmitter.

20. The method of claim 19, wherein the configuring step adjusts the PN sequence of the transmitter to at least reduce an effect on the transmitter caused by delaying the timing signal.

21. The method of claim 20, wherein the configuring step adjusts an initial state of a PN code of the transmitter.

22. The method of claim 20, wherein the configuring step adjusts a PN code offset value.

23. The method of claim 20, wherein the configuring step adjusts a frame offset for at least one channel to eliminate an effect caused by delaying the timing signal.

24. The method of claim 23, wherein the channel is a forward link channel.

25. The method of claim 15, wherein the configuring step adjusts a frame offset for at least one channel to eliminate an effect caused by delaying the timing signal.

26. The method of claim 25, wherein the processing device includes a transmitter and the channel is a forward link channel.
